(19) United States
(12) Patent Application Publication
(10) Pub. No.: US 2024/0075417 A1
(43) Pub. Date: Mar. 7, 2024

(54) Method for determining the degree of soiling of an air filter

(71) Applicant: HELLA GmbH & Co. KGaA, Lippstadt (DE)

(72) Inventors: Thomas Niemann, Delmenhorst (DE); Torsten Eggers, Ganderkese (DE); Arne Müller, Bremerhaven (DE)

(21) Appl. No.: 18/458,819

(22) Filed: Aug. 30, 2023

(30) Foreign Application Priority Data
Sep. 1, 2022 (DE) 102022122139.3

(51) Int. Cl. B01D 46/00; B01D 46/44

(52) U.S. Cl. CPC B01D 46/0086; B01D 46/446; B01D 2273/18

(57) ABSTRACT

A method for determining the degree of soiling of an air filter, in particular of an air filter in the interior space of motor vehicle, in which air to be purified is directed across at least one filter body in a predetermined direction of flow. An indirect pressure measurement takes place before and after the at least one filter body in the predefined direction of flow. An apparatus for determining the degree of soiling of an air filter is also provided, having at least one filter body as well as an airflow chamber connected upstream of the filter body and an airflow chamber connected downstream of the filter body. An indirect pressure measurement device is allocated to the airflow chamber connected upstream of the filter body and to the airflow chamber connected downstream of the filter body.

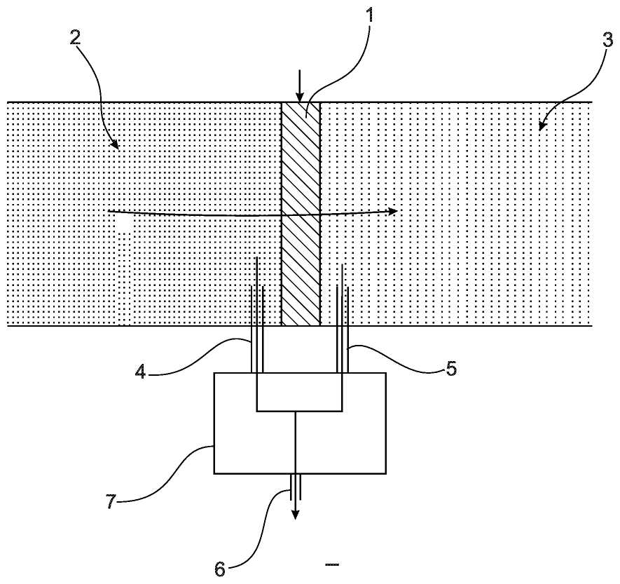

### BACKGROUND OF THE INVENTION

### Field of the Invention

The invention relates to a method for determining the degree of soiling of an air filter, in particular of an air filter in the interior space of motor vehicle, in which air to be purified is directed across at least one filter body in a predetermined direction of flow. The invention also relates to an apparatus for determining the degree of soiling of an air filter, in particular of an air filter in the interior space of a motor vehicle, having at least one filter body as well as an airflow chamber connected upstream of the filter body and an airflow chamber connected downstream of the filter body.

Brief Discussion of the Related Art Air filters of such kind are used predominantly as interior space air filters in motor vehicles. However, depending on the environment or region in which the motor vehicle is used, such filters are often exposed to substantial loading. Then it is very often not sufficient to replace the air filter or interior space air filter within the intended service intervals for the vehicle.

Now in order to be able to replace the air filter when needed in these cases as well, it is necessary to determine a corresponding soiling state of the filter body. The problem addressed by the invention is that of providing sensor system which makes this possible at low cost.

This problem is solved with regard to the method and apparatus of the claims.

### SUMMARY OF THE INVENTION

The method for determining the degree of soiling of an air filter, in particular of an interior space of a motor vehicle in which air to be purified is directed across at least one filter body in a predetermined direction of flow, is characterized according to the invention in that an indirect pressure measurement is carried out before and after the at least one filter body in the predetermined direction of flow. Since an indirect pressure measurement is performed, it is not necessary to design any new parts for carrying the air to be purified on the air filter, so that standard commercial filter bodies and filter inserts may be used without modification.

### BRIEF DESCRIPTION OF THE DRAWINGS

The sole FIGURE is a schematic construction of an air filter according to the invention.

### DETAILED DESCRIPTION OF THE PREFERRED EMBODIMENTS

According to a first further development, the indirect pressure measurement is carried out via a respective volume flow before and after the filter body, which results from a pressure difference between two pressure potentials. In this context, the pressure difference is created by the degree of soiling of the filter body or the filter, which influences the ratio of the pressure potentials with respect to each other.

In a further variant of the invention, the pressure potential before the filter body and the pressure potential after filter body are each considered in proportion to a further, common pressure potential. Thus, an at least indirect relationship exists between the volume flows resulting from the pressure potential. It is advantageous in this case if the common pressure potential is isobaric. Accordingly, it is not necessary to determine the absolute pressure which exists at a certain point in time.

In particular, the respective volume flow is generated between an airflow chamber and an ambient reservoir in the predefined direction of flow before the filter body and between an airflow chamber and the ambient reservoir in the predefined direction of flow after the filter body. In this context, in a simple, inexpensive embodiment the ambient reservoir corresponds to the area around the air filter.

According to a further development, the respective volume flows are measured via the average particle speeds thereof in the fine particulates entrained in each. These are preferred captured by optical means. Consequently, it is possible to dispense with mechanical components that might influence the air flow.

The degree of soiling of the filter body is then calculated by determining the difference for each of the volume flows, from which a pressure drop is then determined at the filter body. The pressure drop is in turn an indicator of the degree of soiling.

The apparatus for determining the degree of soiling of an air filter, in particular an interior space air filter of a motor vehicle, having at least one filter body and an airflow chamber connected upstream of the filter body and an airflow chamber connected downstream of the filter body, is characterized according to the invention in that an indirect pressure measurement device is allocated to the airflow chamber connected upstream of the filter body and the airflow chamber connected downstream of the filter body. The indirect pressure measurement has the advantage that it is not necessary to install a pressure sensor especially to measure the absolute pressure, and the components that carry the air to be purified do not have to be modified or limited.

In a further variant, at least one air channel, in particular exactly one air channel is allocated in each case to the airflow chamber connected upstream of the filter body and the airflow chamber connected downstream of the filter body which connect the respective airflow chambers to the area around the apparatus. Then, air flows into or out of the respective airflow channels depending on a respective degree of soiling of the filter body and a drop in pressure at the filter body associated therewith.

This air volume flow is captured according to the invention, for which, according to a further development, at least one air flow detection unit is allocated to the air channels, which unit may be used to determine an air flow present in any air channel.

In a further variant, an optical sensor is provided as the air flow detection unit, enabling contactless measurement of the volume flows without mechanically moving parts. In this way, the air flow in the channels and at the filter body is not restricted by the air flow detection unit. In order to detect the air or volume flow in the air channels, advantageously at least one fine particulates sensor is also provided, with which corresponding particle speeds may be captured.

Therefore, according to a first preferred embodiment a multichannel fine particulates sensor, in particular a two-channel fine particulates sensor is allocated to the air channels.

This sensor then detects the volume flows in all air channels.

Alternatively, according to a second preferred embodiment, a single-channel fine particulates sensor may also be allocated to each air channel.

In order to render the volume flows comparable in a simple manner, according to a further development it is also provided that all air channels have the same diameter.

An exemplary embodiment of the invention, from which further advantages according to the invention may be derived, is represented in the drawing.

The one FIGURE of the drawing shows the schematic construction of an air filter according to the invention, with a filter body 1, an airflow chamber 2 connected upstream of the filter body 1 in the predefined air flow direction, and an airflow chamber 3 connected downstream of the filter body 1 in the predefined air flow direction. Airflow chamber 2, filter body 1 and airflow chamber 3 together form a filter channel for air that is to be purified. A branching air channel 4, 5 is allocated to each of airflow chamber 2 and airflow chamber 3. The air channels 4, 5 are each aligned at right angles to a primary flow direction A in the filter channel for air that is to be purified.

Both air channel 4 and air channel 5 are connected to an area B around the air filter via a common line section 6 in such manner as to allow air to pass. An air flow detection unit is connected between the line section 6 and the air channels 4, 5. This is a fine particulates sensor 7, which enables optical detection of both volume flows in the air channels 4, 5 via fine particulates entrained in the volume flows, and for this purpose detects the average particle speed thereof. Then, a conclusion may be drawn regarding the pressure drop across the filter body 1 from the difference between the volume flows, and this in turn delivers information about the state of soiling of the filter body 1.

1. A method for determining the degree of soiling of an air filter, in particular an interior space air filter of a motor vehicle, in which air to be purified is directed across at least one filter body in a predetermined direction of flow,
wherein
an indirect pressure measurement is carried out before and after the at least one filter body in the predetermined direction of flow.

2. The method according to claim 1, wherein the indirect pressure measurement is carried out via a respective volume flow before and after the filter body, which results from pressure difference between two pressure potentials.

3. The method according to claim 2, wherein the respective volume flow is generated between an airflow chamber and an ambient reservoir in the predefined direction of flow before the filter body and between an airflow chamber and the ambient reservoir in the predefined direction of flow after the filter body.

4. The method according to ene of claim 2, wherein the respective volume flows are measured via the average particle speeds thereof in the fine particulates entrained in each.

5. The method according to claim 2, wherein the difference is determined for the volume flows, from which then a pressure drop at the filter body is determined.

6. An apparatus for determining the degree of soiling of an air filter, in particular of an interior space air filter of a motor vehicle, having at least one filter body and an airflow chamber connected upstream of the filter body, and an airflow chamber connected downstream of the filter body,
wherein
an indirect pressure measurement device is allocated to the airflow chamber connected upstream of the filter body and to the airflow chamber connected downstream of the filter body.

7. The apparatus according to claim 6, wherein the at least one air channel, in particular exactly one air channel is allocated in each case to the airflow chamber connected upstream of the filter body and the airflow chamber connected downstream of the filter body, which connect the respective air flow chambers to an area around the apparatus.

8. The apparatus according to claim 6, wherein at least one air flow detection unit is allocated to the air channels, with which an air flow present therein may be determined for each air channel.

9. The apparatus according to claim 6, wherein a multichannel fine particulates sensor, in particular a two-channel fine particulates sensor is allocated to the air channels.

10. The apparatus according to claim 6, wherein a single-channel fine particulates sensor is allocated to each air channel.

11. A motor vehicle equipped with at least one interior space air filter,
wherein
the interior space air filter includes an apparatus for determining the degree of soiling of an air filter according to claim 6.
